(19) United States
(12) Patent Application Publication
(10) Pub. No.: US 2025/0365208 A1
(43) Pub. Date: Nov. 27, 2025

(54) SYSTEM AND METHOD OF FACILITATING PREDICTIVE BEHAVIORAL ANALYSIS BY INTEGRATING ONE OR MORE INTELLIGENT COMMUNICATIVE AGENTS

(71) Applicant: Affle (India) Limited, India, Gurugram (IN)

(72) Inventors: Anuj Khanna SOHUM, Singapore (SG); Charles Yong Jien FOONG, Templestowe (AU); Madhusudana RAMAKRISHNA, Singapore (SG)

(73) Assignee: Affle (India) Limited, India, Gurugram (IN)

(21) Appl. No.: 19/216,023

(22) Filed: May 22, 2025

(30) Foreign Application Priority Data
May 22, 2024 (IN) 202311079249

(51) Int. Cl. H04L 41/147; G06N 5/043; H04L 41/16

(52) U.S. Cl. CPC H04L 41/147; G06N 5/043; H04L 41/16

(57) ABSTRACT

Systems and methods for progressive training, heartbeat validation, and error minimization in intelligent agent systems for predictive purchasing and behavior mimicry are disclosed. The system discloses progressive training providing a hierarchy of intelligence, from basic list compilation to advanced predictive models based on user behavior, collaborative device input, social preferences, and budget considerations. The system further discloses heartbeat validation addresses evolving user preferences by intermittently seeking human input, comparing it to responses generated by the intelligent agents, and triggering re-training if deviations surpass a defined threshold. The system further discloses error minimization training which focuses on replicating user intent accurately, employing prompts, satisfaction assessments, and input from other agents. When decision-making involves multiple agents, a comprehensive training approach ensures consistent performance.

### CROSS REFERENCE TO RELATED APPLICATIONS

This patent application claims priority to Indian Patent Application No. IN 202311079249, filed May 22, 2024, entitled “METHOD AND SYSTEM FOR PROGRESSIVE TRAINING, HEARTBEAT VALIDATION, AND ERROR MINIMIZATION IN INTELLIGENT AGENT SYSTEMS FOR PREDICTIVE PURCHASING AND BEHAVIOR MIMICRY” and assigned to the assignee hereof. The disclosure of the prior application is considered part of and is incorporated by reference in this patent application.

### TECHNICAL FIELD

Embodiments of the present disclosure generally relate to artificial intelligence (AI) based systems and more particularly to method and system for progressive training, heartbeat validation, and error minimization in intelligent agent systems for predictive purchasing and behavior mimicry.

### BACKGROUND

Training an intelligent agent to perform specific tasks or make accurate predictions typically requires a substantial amount of time and data. In certain scenarios, users may lack the patience to engage in a single extended training session. The conventional approach to training intelligent agents poses significant challenges for users seeking prompt and efficient outcomes. Firstly, the time-intensive nature of agent training may overwhelm users, discouraging them from engaging in extended training sessions. Secondly, the absence of a secure mechanism for sharing training information amongst agents leads to redundant training efforts, consuming valuable computational resources and potentially causing inconsistencies in agent behavior.

Furthermore, in multi-agent environments, it is crucial to avoid redundancy in training efforts. Duplicate training of agents not only consumes valuable computational resources but may also lead to inconsistencies and inefficiencies in the behavior of intelligent agents. Thus, a secure mechanism for sharing training information among agents is paramount to optimize the overall training process.

Despite advancements in intelligent predictive systems, there exists a critical gap in their ability to provide accurate and personalized recommendations for purchasing decisions. Current systems often lack the comprehensive understanding of user preferences, behavioral patterns, and contextual information required to make truly informed predictions. While some systems may excel in one area, they falter in others, resulting in suboptimal recommendations. Furthermore, the absence of a structured training methodology leads to inefficient utilization of available data, limiting the system's potential to adapt and improve over time.

Therefore, there is a need for a training mechanism that enables the progressive acquisition of knowledge and skills by the agent, allowing for intermittent training sessions without sacrificing overall learning efficacy.

Consequently, there is a need for improved method and system for progressive training, heartbeat validation, and error minimization in intelligent agent systems for predictive purchasing and behavior mimicry to address the aforementioned issues.

### OBJECTS OF THE INVENTION

Some of the objects of the present disclosure, which at least one embodiment herein satisfy, are listed herein below.

It is an object of the present subject matter to overcome the afore mentioned and other drawbacks existing in the prior art systems and methods.

It is a significant object of the present subject matter to design and develop a system and an associated method that is capable of facilitating predictive behavioral analysis by integrating one or more intelligent communicative agents.

It is another principal object of the present subject matter to design and develop the system such that the system is able to facilitate progressive training, heartbeat validation and error minimization for intelligent agents.

It is another object of the present subject matter to design and develop the system such that the system facilitates progressive training, heartbeat validation and error minimization for intelligent agents particularly for predictive purchasing and behavior mimicry.

It is another object of the present subject matter to design and develop the system where the system is equipped with appropriate provisions for handling sensitive data.

It is another object of the present subject matter to design and develop the system where the system ensures response quality, personalization and evolution of communicative agent's behavior over time.

It is even another object of the present subject matter to design and develop the system such that the system is simple to implement.

These and other objects and advantages of the present subject matter will be apparent to a person skilled in the art after consideration of the following detailed description, taken into consideration with accompanied drawings in which preferred embodiments of the present subject matter are illustrated.

### SUMMARY OF THE INVENTION

This summary is provided to introduce concepts related to a system for facilitating predictive behavioral analysis by integrating one or more intelligent communicative agents. The concepts are further described below in the detailed description. This summary is not intended to identify key features or essential features of the claimed subject matter, nor is it intended to be used to limit the scope of the claimed subject matter.

According to an embodiment of the present subject matter, there is provided the system facilitating predictive behavioral analysis by integrating one or more intelligent communicative agents.

In an aspect, the system comprises at least one primary intelligent communicative agent, a plurality of secondary intelligent communicative agents, where each of the plurality of secondary intelligent communicative agents are associated with scope of a predefined field, a memory unit, where the memory unit is configured to store information related to the at least one primary intelligent communicative agent and the plurality of secondary intelligent communicative agents, one or more processors, where one or more processors is configured to trigger communicative interaction between the at least one primary agent and the plurality of secondary intelligent communicative agents.

In an aspect, the one or more processor comprises a heartbeat validation engine, where the heartbeat validation engine is configured to monitor and adapt to changes based on communication between the at least one primary agent and the plurality of secondary intelligent communicative agents, a progressive training engine, where the progressive training engine is configured to train the plurality of secondary intelligent communicative agents based on information received from the heartbeat validation engine, an output engine, configured to receive real time response from the plurality of secondary intelligent communicative agents, an error minimization engine, where the error minimization engine is configured to adapt the plurality of secondary intelligent communicative agents based on information received from the progressive training engine and the output engine, one or more communication networks, where the one or more communication networks are configured to receive as generated real time information from the at least one primary intelligent communicative agent and transmit the real-time information to one or more user devices communicatively coupled to the system and a database configured to receive information from the system by means of the one or more communication networks and store the information for future purposes.

In an aspect, the error minimization engine is configured to adapt the at least one primary intelligent communicative agent and the plurality of secondary intelligent communicative agents via the heartbeat validation engine and the progressive training engine based on real time feedback received by the system from one or more user devices.

In an aspect, there is provided a central server configured to store and process information exchanged through the one or more communication networks.

In an aspect, the one or more processors are configured to selectively trigger inter-communication between the at least one primary intelligent communicative agent and the plurality of secondary intelligent communicative agents by identifying the required field upon receipt of request by means of the one or more user devices.

In an aspect, the at least one primary communicative agent is configured to delegate task to one or more of the plurality of secondary intelligent communicative agents upon identifying required field of request.

In an aspect, the information stored in the database is encrypted for security purposes.

In an aspect, the one or more processors comprises of an access control device configured to authenticate access to each of the plurality of secondary intelligent communicative agents such that each of the plurality of secondary intelligent communicative agents operate within the predefined field.

In an aspect, at least one primary intelligent communicative agent co-ordinates with each of the plurality of secondary intelligent communicative agents and among the plurality of secondary intelligent communicative agents by following a two-way intercommunication protocol implemented by neural networks thereby dynamically adjusting communication pathway.

In an aspect, the at least one primary intelligent communicative agent is configured to weigh inputs received from each of the plurality of secondary intelligent communicative agents based on their relevance to the current task and their historically validated performance within their predefined field.

In an aspect, the system is configured to allow independent inter-communication between each of the plurality of secondary intelligent communicative agents.

In an aspect, the plurality of secondary intelligent communicative agents may include but is not limited to device agent, social agent, budget agent and the like.

In an aspect, there is provided a method for facilitating predictive behavioral analysis by integrating one or more intelligent communicative agents, the method comprising receiving request by at least one primary intelligent communicative agent, identifying nature of request by at least one primary intelligent communicative agent, triggering communication with one or more of the plurality of secondary intelligent communicative agents by means of one or more processors based on nature of request received by the at least one primary intelligent communicative agent, delegating task by at least one primary intelligent communicative agent to the one or more of the plurality of secondary intelligent communicative agents by means of one or more processors based on nature of request, transmitting as generated real time information by the at least one primary agent to one or more communication networks, transmitting the generated real-time information to one or more user devices by the one or more communication networks upon receipt, adapting the at least one primary intelligent communicative agent and the plurality of secondary intelligent communicative agents by the one or more processors based on feedback received from one or more user devices and iterating above steps to train the at least one primary intelligent communicative agent and the plurality of secondary intelligent communicative agents.

In an aspect, the method includes configuring the one or more processors to monitor and adapt to changes based on communication between the at least one primary agent and the plurality of secondary intelligent communicative agents by a heartbeat validation engine, train the plurality of secondary intelligent communicative agents based on information received from the heartbeat validation engine by a progressive training engine, receive real time response from the plurality of secondary intelligent communicative agents by an output engine and adapt the plurality of secondary intelligent communicative agents as well as the at least one primary intelligent communicative agent based on information received from the progressive training engine and the output engine by an error minimization engine.

In an aspect, the method includes configuring the error minimization engine to adapt the at least one primary intelligent communicative agent and the plurality of secondary intelligent communicative agents via the heartbeat validation engine and the progressive training engine based on real time feedback received from one or more user devices.

In an aspect, the method includes selectively triggering inter-communication between one or more secondary intelligent communicative agents of the plurality of secondary intelligent communicative agents by identifying the required field.

In an aspect, the method includes authenticating access to each of the plurality of secondary intelligent communicative agents by the one or more processors such that each of the plurality of secondary intelligent communicative agents operate within the predefined field.

In an aspect, the method includes performing inter-communication between at least one primary intelligent communicating agent and the plurality of secondary intelligent communicative agents and among the plurality of secondary intelligent communicative agents by following a two-way intercommunication protocol implemented by neural networks.

In an aspect, the method includes configuring a central server to store and process information exchanged through the one or more communication networks.

In an aspect, the method includes encrypting the information stored in the database for security purposes.

In an aspect, there is provided a non-transitory machine-readable medium including data, which when used by a system for facilitating predictive behavioral analysis by integrating one or more intelligent communicative agents, causes the system to perform instructions that cause the system to perform operations, comprising receiving request by at least one primary intelligent communicative agent, identifying nature of request by at least one primary intelligent communicative agent, triggering communication with one or more of the plurality of secondary intelligent communicative agents by means of one or more processors based on nature of request received by the at least one primary intelligent communicative agent, delegating task by at least one primary intelligent communicative agent to the one or more of the plurality of secondary intelligent communicative agents by means of one or more processors based on nature of request, transmitting as generated real time information by the at least one primary agent to one or more communication networks, transmitting the generated real-time information to one or more user devices by the one or more communication networks upon receipt, adapting the at least one primary intelligent communicative agent and the plurality of secondary intelligent communicative agents by the one or more processors based on feedback received from one or more user devices and iterating above steps to train the at least one primary intelligent communicative agent and the plurality of secondary intelligent communicative agents.

To further understand the characteristics and technical contents of the present subject matter, a description relating thereto will be made with reference to the accompanying drawings. However, the drawings are illustrative only but not used to limit the scope of the present subject matter.

Various objects, features, aspects, and advantages of the inventive subject matter will become more apparent from the following detailed description of preferred embodiments, along with the accompanying drawing figures in which numerals represent like components.

### BRIEF DESCRIPTION OF THE DRAWINGS

The disclosure will be described and explained with additional specificity and detail with the accompanying figures in which:

FIG. 1 illustrates an exemplary block diagram representation of a network architecture implementing a method and system for progressive training, heartbeat validation, and error minimization in intelligent agent systems for predictive purchasing and behavior mimicry, in accordance with an exemplary embodiment of the present disclosure;

FIG. 2 illustrates an exemplary block diagram representation of a computer implemented system, such as those shown in FIG. 1, capable of providing progressive training, heartbeat validation, and error minimization in intelligent agent systems for predictive purchasing and behavior mimicry, in accordance with an exemplary embodiment of the present disclosure;

FIG. 3 illustrates an exemplary flow diagram representation depicting process of providing progressive training, heartbeat validation, and error minimization in intelligent agent systems for predictive purchasing and behavior mimicry, in accordance with an exemplary embodiment of the present disclosure; and

FIG. 4 depicts an example method of operation of the system in accordance with an exemplary embodiment of the present disclosure.

The figures depict embodiments of the present subject matter for the purposes of illustration only. A person skilled in art will easily recognize from the following description that alternative embodiments of the structures and methods illustrated herein may be employed without departing from the principles of the disclosure described herein.

Further, those skilled in art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. The appearance of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Embodiments of the present disclosure provide method and system for progressive training, heartbeat validation, and error minimization in intelligent agent systems for predictive purchasing and behavior mimicry. The present system enables intelligent communicative agents to provide a progressive training mechanism implemented by breaking down the training process into distinct stages, each focused on developing a specific aspect of the agent's intelligence hierarchy. This hierarchy encompasses various levels of proficiency, ranging from basic list compilation to sophisticated predictive capabilities based on behavioral, collaborative, and social insights, as well as budget considerations.

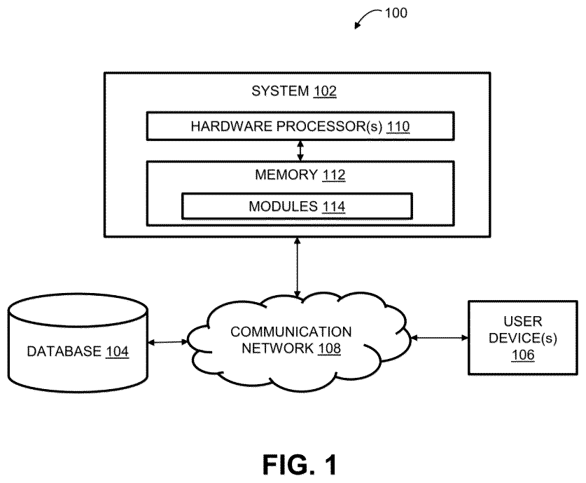

Referring now to the drawings, and more particularly to FIG. 1 through FIG. 4, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture (100) implementing a system (102) for progressive training, heartbeat validation, and error minimization in intelligent agent systems for predictive purchasing and behavior mimicry, in accordance with an exemplary embodiment of the present disclosure. According to FIG. 1, the network architecture (100) includes a system (102), a database (104), and one or more user devices (106). The one or more user devices (106) may be associated with one or more users and communicatively coupled to the system (102) via one or more communication networks (108).

In an exemplary embodiment of the present disclosure, the user devices (106) may include a laptop computer, desktop computer, tablet computer, smartphone, wearable device, a digital camera, and the like. Further, the communication network (108) may be a wired network or a wireless network.

In an aspect, the system (102) may be at least one of, but not limited to, a central server, a cloud server, a remote server, an electronic device, a portable device, and the like. Further, the system (102) may be communicatively coupled to the database (104), via the communication network (108). The database (104) may include, but is not limited to, personal data, health data, lifestyle data, any other data, and combinations thereof. The database (104) may be any kind of database/repositories such as, but are not limited to, relational database, dedicated database, dynamic database, monetized database, scalable database, cloud database, distributed database, any other database, and combination thereof.

Further, the user device (106) may be associated with, but not limited to, a user, an individual, an administrator, a vendor, a technician, a worker, a specialist, a healthcare worker, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device (106) may be used to provide input and/or receive output to/from the system (102), and/or to the database (104), respectively. The user device (106) may present to the user one or more user interfaces for the user to interact with the system (102) and/or to the database (104) for progressive training, heartbeat validation, and error minimization in intelligent agent systems for predictive purchasing and behavior mimicry. The user device (106) may be at least one of, an electrical, an electronic, an electromechanical, and a computing device. The user device (106) may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the system (102) may be implemented by way of a single device or a combination of multiple devices that may be operatively connected or networked together. The system (102) may be implemented in hardware or a suitable combination of hardware and software. The system (102) may include one or more processor(s) (110), and a memory (112). The memory (112) may include a plurality of modules (114). The system (102) may be a hardware device including the processor (110) executing machine-readable program instructions for providing progressive training, heartbeat validation, and error minimization in intelligent agent systems for predictive purchasing and behavior mimicry. Execution of the machine-readable program instructions by the processor (110) may enable the proposed system (102) to provide progressive training, heartbeat validation, and error minimization in intelligent agent systems for predictive purchasing and behavior mimicry. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors (110) may include, for example, microprocessors, microcomputers, microcontrollers, digital signal processors, central processing units, state machines, logic circuits, and/or any devices that manipulate data or signals based on operational instructions. Among other capabilities, processors (110) may fetch and execute computer-readable instructions in the memory (112) operationally coupled with the system (102) for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, sensors, any other devices, and combination thereof. The person skilled in art should not be limiting the components/subsystems shown in FIG. 1. Although FIG. 1 illustrates the system (102), and the user device (106) connected to the database (104), one skilled in the art can envision that the system (102), and the user device (106) can be connected to several user devices located at various locations and several databases via the communication network (108).

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system (102) as is unique to the present disclosure or necessary for an understanding of the present disclosure is depicted and described. The remainder of the construction and operation of the system (102) may conform to any of the various current implementations and practices that were known in art.

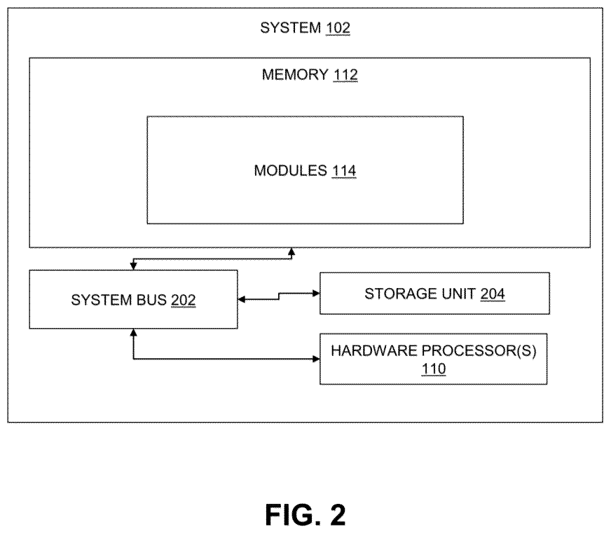

FIG. 2 illustrates an exemplary block diagram representation of the computer implemented system (102), such as those shown in FIG. 1, capable of providing progressive training, heartbeat validation, and error minimization in intelligent agent systems for predictive purchasing and behavior mimicry, in accordance with an exemplary embodiment of the present disclosure.

In an aspect, the system (102) may comprise of at least one primary intelligent communicative agent (302) (may also be referred to as an AI agent (302)), a plurality of secondary intelligent communicative agents (310, 312, 314), where each of the plurality of secondary intelligent communicative agents (310, 312, 314) are associated with scope of a predefined field, a memory unit (112), where the memory unit (112) is configured to store information related to the at least one primary intelligent communicative agent (302) and the plurality of secondary intelligent communicative agents (310, 312, 314), one or more processors (110), where one or more processors (110) is configured to trigger communicative interaction between the at least one primary agent (302) and the plurality of secondary intelligent communicative agents (310, 312, 314). Herein, the at least one primary communicative agent (302) is configured to delegate specific task to one or more of the plurality of secondary intelligent communicative agents (310, 312, 314) upon identifying required field of request.

In an aspect, the one or more processors (110) are configured to selectively trigger inter-communication between the at least one primary intelligent communicative agent (302) and the plurality of secondary intelligent communicative agents (310, 312, 314) by identifying the required field upon receipt of request by means of the one or more user devices (106).

In an aspect, the one or more processors (110) may further comprise a heartbeat validation engine (304), a progressive training engine (306), an output engine (316) and an error minimization engine (308).

In an aspect, the heartbeat validation engine (304) is configured to monitor and adapt to changes based on communication between the at least one primary agent (302) and the plurality of secondary intelligent communicative agents (310, 312, 314).

In an aspect, the progressive training engine (306) is configured to train the plurality of secondary intelligent communicative agents (310, 312, 314) based on information received from the heartbeat validation engine (304).

In an aspect, an output engine (316) is configured to receive real time response from the plurality of secondary intelligent communicative agents (310, 312, 314).

In an aspect, the error minimization engine (308) is configured to adapt the plurality of secondary intelligent communicative agents (310, 312, 314) based on information received from the progressive training engine (306) and the output engine (316). The error minimization engine (308) is configured to adapt the at least one primary intelligent communicative agent (302) and the plurality of secondary intelligent communicative agents (310, 312, 314) via the heartbeat validation engine (304) and the progressive training engine (306) based on real time feedback received by the system (102) from one or more user devices (106).

In an aspect, further, the system (102) may also comprise one or more communication networks (108) configured to receive as generated real time information from the at least one primary intelligent communicative agent (302) and transmit the real-time information to one or more user devices (106) communicatively coupled to the system (102) and also there is provided the database (104) configured to receive information from the system (102) by means of the one or more communication networks (108) and store the information for future purposes.

In an aspect, the information stored in the database (104) is encrypted for security purposes.

In an aspect, the one or more processors (110) may further comprise of an access control device configured to authenticate access to each of the plurality of secondary intelligent communicative agents (310, 312, 314) such that each of the plurality of secondary intelligent communicative agents (310, 312, 314) operate within the predefined field.

In an aspect, herein at least one primary intelligent communicative agent (302) co-ordinates with each of the plurality of secondary intelligent communicative agents (310, 312, 314) and among the plurality of secondary intelligent communicative agents (310, 312, 314) by following a two-way intercommunication protocol implemented by neural networks.

In an aspect, the system (102) is configured to allow independent inter-communication between each of the plurality of secondary intelligent communicative agents (310, 312, 314).

It may be noted herein that an inventive aspect of this protocol lies in its ability to dynamically adjust communication pathways and information routing based on the evolving capabilities of the agents (due to progressive training) and the immediate context of the user request. The neural network components may be trained not only to transmit data but also to learn optimal communication strategies, such as when to broadcast information, when to engage specific secondary agents, and how to aggregate potentially conflicting information from multiple secondary agents. For instance, attention mechanisms within the neural protocol can allow the primary agent (302) to weigh the inputs from the plurality of secondary agents (310, 312, 314) based on their relevance to the current task and their historically validated performance within their predefined field.

Furthermore, this neural network-based protocol is configured to support the feedback mechanisms essential for the Heartbeat Validation Engine (304) and the Error Minimization Engine (308). It can facilitate the propagation of error signals or adaptation commands from these engines back to the relevant primary (302) or secondary agents (310, 312, 314), enabling synchronized updates and learning across the distributed agent system. The “two-way” nature ensures that information for adaptation flows efficiently, allowing the entire system (102) to learn and adjust its internal communication and coordination patterns over time, thereby enhancing the overall predictive behavioral analysis and mimicry capabilities. The training of this communication protocol itself may be part of the overall system's learning process, optimized to improve task delegation accuracy and response generation efficiency.

In an aspect, the plurality of secondary intelligent communicative agents (310, 312, 314) may include but is not limited to device agent (310), social agent (312), budget agent (314) and the like.

In an exemplary embodiment, the system (102) may provide progressive training, heartbeat validation, and error minimization in intelligent agent systems for predictive purchasing and behavior mimicry.

In an exemplary embodiment, the progressive training engine (306) of the system (102) facilitates progressive training within an intelligent agent system, which entails that a multi-stage process is provided. Initially, the system (102) establishes a hierarchy of intelligence, encompassing list-based collation, behavioral analysis, collaborative analysis with the plurality of secondary intelligent communicative agents (310, 312, 314). These stages collectively serve to generate precise predictions for purchasing based on user-specific input and historical data. The purpose of progressive training is to build and refine an intelligent predictive system's capabilities by breaking the training process into distinct stages, each focused on a particular aspect of intelligence. This hierarchical approach allows the system (102) to gradually acquire knowledge and improve its predictive capabilities over time.

In a preferred embodiment, the key stages of progressive training as performed by the progressive training engine (306) may be listed as follows:
a. List-Based Intelligence: In the initial stage of progressive training, the system (102) is trained to collate a list of items based on a user's request to purchase. This basic level of intelligence involves identifying and listing items that match the user's immediate requirements.
b. Behavioral Predictions: Building upon the basic list-based intelligence, the system (102) progresses to analyze the user's historical purchasing patterns. For example, by understanding what the user has bought in the past, the system (102) may predict what the user may want to purchase in the future. This stage of training enables the system (102) to offer personalized recommendations based on the user's behavior.
c. Collaborative Intelligence with Device Agents: In this stage, the system (102) extends its intelligence by collaborating with device agents, such as smart appliances like refrigerators. By leveraging information about the contents of the refrigerator and their expiration dates, the system (102) can make more accurate predictions about what the user needs to purchase. This collaborative approach enhances predictive capabilities of the system (102) by incorporating real-time data from household devices.
d. Social Predictions: To further refine its predictions, the system (102) may tap into social dynamics within a household. By considering the preferences and input of other household members, the system (102) can make predictions on what items to purchase. This stage recognizes the importance of collective decision-making in the context of shared living spaces.
e. Collaboration with Budget Agents: The final stage of Progressive Training involves cooperation with budget agents. By integrating information about the user's or household's budget constraints, the system (102) may make predictions that are not only based on what is needed but also within the financial means of the user. This ensures that purchasing decisions align with the user's financial goals.

Therefore, progressive training is an innovative approach that allows intelligent predictive systems to evolve and adapt to users' needs and circumstances, enhancing the accuracy and relevance of their recommendations. As the system (102) continues to develop and integrate the various stages of training, they have the potential to revolutionize the way individuals and households make purchasing decisions, ultimately saving time and money while reducing waste and improving overall consumer satisfaction. This approach represents a significant advance in the field of predictive systems, creating more sophisticated and user-centric tools for making informed buying decisions.

In an exemplary embodiment, the heartbeat validation engine (304) of the system (102) introduces a dynamic preference assessment method, which involves monitoring shifts in user preferences over time. By comparing current preferences to historical data, the system (102) may determine the extent of deviation. If a significant deviation is detected, it triggers a re-training process to ensure that the intelligent communicative agent aligns with the evolving preferences of the user.

In order to enhance performance, the system (102) may further incorporate a human input to validate the agent's generated responses. This validation process involves comparing the responses provided by humans with those generated by the agents, establishing confidence levels for each answer. This valuable feedback loop is then utilized to refine and improve the intelligent communicative agents, leading to more accurate and reliable outputs.

In an aspect, the system (102) may further also implement an adaptive training approach for intelligent communicative agents, integrating a feedback loop with human intervention based on response generated from the one or more user devices (106) in order to validate agent's generated outputs. Through the analysis of human-provided responses, the system (102) assesses the accuracy and confidence level of the agents. These validated responses are subsequently integrated into the training process, contributing to the ongoing refinement of the agent's capabilities.

To ensure a seamless user experience, the system (102) may employ a mechanism for scheduling additional user queries when necessary. This is determined by tracking the cumulative deviation of agent generated responses from user preferences and setting a threshold for acceptable deviation levels. If the cumulative deviation exceeds this threshold, supplementary questions are automatically scheduled to gather further insights from the user. For example, scheduling additional user queries is achieved by tracking the cumulative deviation of agent generated responses from user preferences and setting a threshold for acceptable deviation levels. Supplementary questions are triggered if the cumulative deviation surpasses the defined threshold, ensuring that users receive accurate and tailored responses from the AI system.

In an exemplary embodiment, the heartbeat validation engine (304) operates on a foundation of continuous improvement, where it monitors user preferences and behavior patterns over time. By determining the deviation between current preferences and historical data, the system (102) identifies areas for potential refinement. This may lead to the initiation of re-training or validation processes, ensuring that the agents remain aligned with the user's evolving preferences and needs. For instance, when deviations are detected, re-training or validation processes are initiated to adapt the agent's capabilities and maintain its relevance and accuracy.

In an exemplary embodiment, the system (102) may provide confidence-based training of intelligent communicative agents, which involves employing human judgment to validate agent's generated responses and establishing confidence levels for each response based on human validation. These confidence scores are then used to inform re-training and refinement of models, leading to more reliable and accurate interactions by the agents.

The system (102) may act as a personalized agent interaction system which dynamically tracks changes in user preferences and tastes while verifying agent's generated responses through human validation. The validation results are used to adapt and optimize agent's interactions for individual users, ensuring that the AI system caters to users' changing preferences over time.

In another exemplary embodiment, the error minimization engine (308) of the system (102) provides a mechanism for error minimization training. This mechanism includes usage of prompts to guide user interactions and elicit intended behaviors. Furthermore, the system (102) incorporates evaluation of user satisfaction levels with responses, enabling the fine-tuning of the model's behavior to more accurately mimic the user's desired actions.

In an exemplary embodiment, the system (102) is designed to replicate intended user behavior. The system (102) involves a feedback mechanism that rigorously assesses and validates the responses generated by the system (102). Additionally, the system (102) considers the input of other intelligent communicative agents or coordinators in the decision-making process, ensuring a comprehensive approach to error minimization.

In an exemplary embodiment, the method of error minimization training involves a training process that extends to all agents involved in the decision-making pathway. This extensive training approach is aimed at guaranteeing that the model consistently delivers accurate and reliable results. The satisfaction levels of user responses are utilized as a key metric for continually improving the model's performance.

In a coordinator-based error minimization training system, coordinators are pivotal in the determination of model responses. However, the training process extends to encompass all agents participating in the decision-making path to ensure their synchronized behavior, thus minimizing errors in user behavior replication.

In an exemplary embodiment, the system (102) incorporates a network of intelligent communicative agents working collaboratively to generate responses, making it a collective effort to ensure that intended user behaviors are faithfully reproduced. Training all agents involved in the decision-making process is integral to achieving a harmonized and error-minimized user experience.

A fundamental part of the error minimization training process is the use of prompts to guide user interactions and elicit specific desired outcomes. Furthermore, the responses generated are systematically validated through feedback mechanisms that involve both users and other agents within the system, thereby enhancing the overall quality of the user experience.

In an Error Minimization Training framework, a critical component is the mechanism for incorporating input from multiple agents in the response determination process. This framework entails training all agents along the decision path, which is essential for achieving a consistent and error-minimized user experience, ensuring that intended behaviors are faithfully replicated.

In an aspect, the system (102) may also function as a computer-implemented system/server (hereafter referred to as the system (102)). The system (102) comprises of the one or more processors (110), the memory (112), and a storage unit (204). The one or more processors (110), the memory (112), and the storage unit (204) are communicatively coupled through a system bus (202) or any similar mechanism. The memory (112) comprises a plurality of modules (114) in the form of programmable instructions executable by the one or more processors (110).

The one or more processors (110), as used herein, means any type of computational circuit, such as, but not limited to, a microprocessor unit, microcontroller, complex instruction set computing exceptionally long processor unit, reduced instruction set computing microprocessor unit, very long instruction word microprocessor unit, explicitly parallel instruction computing microprocessor unit, graphics processing unit, digital signal processing unit, or any other type of processing circuit. The one or more processors (110) may also include embedded controllers, such as generic or programmable logic devices or arrays, application-specific integrated circuits, single-chip computers, and the like.

In an aspect, the memory (112) may be a non-transitory volatile memory and a non-volatile memory. The memory (112) may be coupled to communicate with the one or more processors (110), such as being a computer-readable storage medium. The one or more processors (110) may execute machine-readable instructions and/or source code stored in the memory (112). A variety of machine-readable instructions may be stored in and accessed from the memory (112).

In an aspect, the memory (112) may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory (112) may include the plurality of modules (114) stored in the form of machine-readable instructions on any of the above-mentioned storage media and may be in communication with and executed by the one or more processors (110).

In an aspect, the storage unit (204) may be a cloud storage or a repository such as those shown in FIG. 1. The storage unit (204) may store, but is not limited to, data points, personal information, trained datasets, human inputs, responses, confidence score, any other data, and combinations thereof. The storage unit (204) may be any kind of database/repositories such as, but are not limited to, relational database, dedicated database, dynamic database, monetized database, scalable database, cloud database, distributed database, any other database, and combination thereof.

In an exemplary embodiment, the plurality of modules (114) may provide progressive training, heartbeat validation, and error minimization in intelligent agent systems for predictive purchasing and behavior mimicry.

In an exemplary embodiment, the plurality of modules (114) is responsible for the initial stage of progressive training, where the system collates a list of items based on a user's request to purchase. The plurality of modules (114) may employ techniques such as, for example, but not limited to, a natural language processing (NLP) and item categorization to identify and list items that align with the user's immediate requirements.

In an exemplary embodiment, the plurality of modules (114) focuses on analyzing the user's historical purchasing patterns. The plurality of modules (114) employs machine learning algorithms to identify trends, preferences, and recurrent buying behavior. This analysis forms the basis for making predictions about the user's future purchases.

In an exemplary embodiment, the plurality of modules (114) enables collaborative intelligence with device agents (310), such as smart appliances like refrigerators. It establishes communication protocols to retrieve real-time information about the contents of the refrigerator, including item types and expiration dates. Machine learning models process this data to make accurate predictions about what the user needs to restock.

In an exemplary embodiment, the plurality of modules (114) taps into the social dynamics within a household. The plurality of modules (114) employs collaborative filtering techniques and user preference modeling to consider the input and preferences of other household members. By understanding collective decision-making patterns, the plurality of modules (114) contributes to making accurate predictions on what items to purchase.

In an exemplary embodiment, the plurality of modules (114) cooperates with budget agents to incorporate financial constraints into the prediction process. The plurality of modules (114) leverages financial data, including individual or household budgets, to ensure that the system's recommendations align with the user's financial goals. The plurality of modules (114) employs optimization algorithms to balance needs and budget constraints.

In an exemplary embodiment, the plurality of modules (114) coordinates and manages the progression through the stages of training. The plurality of modules (114) ensures that each module operates in sync, passing relevant information and insights to subsequent stages. The plurality of modules (114) also monitors the system's performance and facilitates continuous improvement of predictive capabilities.

In an exemplary embodiment, the plurality of modules (114) may collect and incorporate user feedback into the training process. It enables the system (102) to learn from user interactions, preferences, and purchase decisions. The feedback loop module employs reinforcement learning techniques to adapt and refine the predictive models based on real-world user experiences.

In an exemplary embodiment, the plurality of modules (114) focuses on adapting the system to individual user preferences and circumstances. It employs reinforcement learning, personalized recommendation algorithms, and contextual modeling to fine-tune predictions for each user, ensuring that recommendations are highly relevant and tailored to specific needs.

In an exemplary embodiment, the plurality of modules (114) monitor shifts in user preferences over time. By analyzing historical data, this module identifies any significant deviations in what users prefer. When such deviations are detected, it prompts the need for a re-training process to ensure that the intelligent communicative agent remains aligned with evolving user preferences.

In an exemplary embodiment, the plurality of modules (114) may prompt a human for input. This human-generated response is then compared with the agent's potential answers to evaluate performance and refine training.

In an exemplary embodiment, the plurality of modules (114) assesses the confidence levels associated with agent's responses. This information is then compared against human-generated responses to determine if the agent could have answered correctly within an acceptable confidence threshold. The plurality of modules (114) aid in gauging the agent's self-assuredness in its responses.

Furthermore, the plurality of modules (114) tracks deviation trends over time. The plurality of modules (114) determines and accumulates deviations between agent's generated responses and human-generated responses. If the cumulative deviation surpasses a predefined threshold, the plurality of modules (114) triggers the initiation of additional questions for the user. This ensures that significant deviations are addressed promptly.

In an exemplary embodiment, the plurality of modules (114) aims to emulate the user's intended behavior accurately. The plurality of modules (114) achieves this by leveraging prompts, user satisfaction levels, and feedback from other agents to train the intelligent communicative agents in generating responses that closely align with the user's desired outcome.

Additionally, the plurality of modules (114) ensures that all agents down the decision-making path are included in the training process. By harmonizing the responses of all involved agents, the plurality of modules (114) facilitates a seamless and consistent user experience.

In an exemplary embodiment, the plurality of modules (114) is responsible for verifying the effectiveness of agent's generated responses. The plurality of modules (114) collects feedback from users and other agents regarding the outcome of agent's generated responses. This valuable input is then used to fine-tune the agent's behavior, ensuring that it consistently delivers satisfactory results.

The plurality of modules (114) further focuses on assessing the impact of prompts on response quality. Through rigorous analysis, the plurality of modules (114) evaluates the effectiveness of different prompts in eliciting the desired user behaviors. This information is invaluable in refining the prompting strategy, ultimately enhancing the overall performance of the system (102).

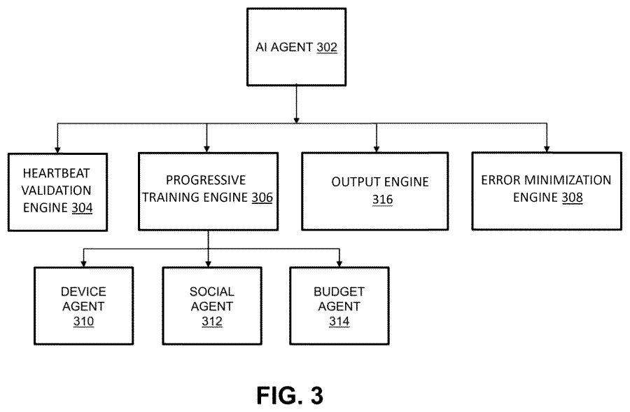

FIG. 3 illustrates an exemplary flow diagram representation depicting process of providing progressive training, heartbeat validation, and error minimization in intelligent agent systems for predictive purchasing and behavior mimicry, in accordance with an exemplary embodiment of the present disclosure. As already mentioned, the system (102) employs a multifaceted approach to address the issue by means of the heartbeat validation engine (304), the progressive training engine (306), and the error minimization engine (308).

In an exemplary embodiment, the progressive training is a comprehensive approach that encompasses various stages, each designed to enhance the system's intelligence in distinct ways. Initially, the system (102) starts with a foundational step, where it compiles a list of potential items for purchase based on user input. This forms the bedrock upon which subsequent stages build. Moving forward, the behavioral stage comes into play, leveraging historical purchasing data to make informed predictions about future preferences. This step allows the system (102) to adapt and refine its recommendations over time, aligning more closely with individual preferences.

The collaboration with device agents (310) stage introduces a new dimension of intelligence. Here, the system (102) taps into specialized device agents, such as for example, a fridge agent, to gather specific information about the contents within. This data is then used to generate accurate predictions about what items may need replenishing, taking personalization to a higher level. Additionally, the social agent (312) stage factors in the preferences of household members, recognizing that purchase decisions often involve multiple stakeholders. By considering the desires and needs of various individuals within the household, the system (102) aims to offer more relevant and tailored recommendations.

Finally, the collaboration with budget agents (314) stage adds a crucial financial aspect to the process. By integrating information about an individual or household's budget constraints, the system (102) ensures that its recommendations are not only desirable but also financially feasible. This stage helps strike a balance between preferences and practicality, offering a holistic approach to purchasing suggestions. Through these progressive stages, the system (102) continuously evolves, refining its intelligence and adaptability to better serve the user's needs. This multi-faceted approach ensures that the system's (102) recommendations become increasingly personalized and effective over time.

In an exemplary embodiment, the heartbeat validation engine (304) is designed to monitor and adapt to changes in user preferences over time. Th heartbeat validation engine (304) recognizes that user's preferences may evolve, necessitating periodic assessments to ascertain if re-training of the model is necessary. Instead of relying solely on the agent's judgment, human input is sought in this evaluation through one or more user devices (106). A comparison is then made to determine if the agent's response aligns with human judgment within an acceptable level of confidence. This information serves as valuable feedback to refine the system (102) and enhance its performance. In cases where the accumulated deviation surpasses a predefined threshold, the heartbeat validation engine (304) may proactively generate additional queries for the user, ensuring continued accuracy and relevance.

In an exemplary embodiment, error minimization engine (308) prompts to guide user interactions and elicit intended behaviors, while also evaluating user satisfaction levels with responses for fine-tuning. The error minimization engine (308) integrates a feedback mechanism to rigorously validate generated responses and considers input from coordinators or other agents in the decision-making process. Training extends to all agents in the pathway to ensure consistent and accurate outcomes. This coordinated approach minimizes errors in replicating user behavior, ultimately enhancing the model's ability to mimic intended actions effectively.

In an embodiment, behaviors can be also body language, voice, tones, style, dressing sense, three-dimensional (3D) entities and mappings. Further to the types of behaviours outlined in paragraph, the system (102) and its constituent engines (304, 306, 308) are specifically architected to facilitate the learning, adaptation, and replication of such nuanced human characteristics. The Progressive Training Engine (306), for example, may employ a hierarchical approach not only for predictive purchasing but also for behavioural traits. Initial stages may focus on recognizing and categorizing basic behavioural cues (e.g., sentiment from text, general voice inflection from audio input), while subsequent stages integrate multi-modal inputs (e.g., analysing synchronized voice tone, textual context, and, if available, visual cues from 3D entity mappings or user avatar interactions) to build a composite understanding of a user's style or emotional state. Specialized secondary agents (310, 312, 314) might also contribute or process specific behavioural data; for instance, a “style agent” (as a type of secondary agent) could be trained to identify preferences in communication formality or visual aesthetics.

The Heartbeat Validation Engine (304) plays a critical role in maintaining the relevance of this nuanced behaviour mimicry. It may be configured to track shifts not just in explicit preferences but also in implicit behavioural patterns, such as changes in a user's typical response tone, interaction frequency, or preferred communication style over time. Deviations in these nuanced behavioural aspects, when compared to established validated profiles, can trigger re-training or fine-tuning processes within the Progressive Training Engine (306) or the Error Minimization Engine (308). Human input sought during validation may specifically query user satisfaction with the agent's perceived empathy, tone appropriateness, or stylistic alignment, thereby providing targeted feedback for these subjective behavioural traits

The Error Minimization Engine (308) utilizes these inputs and user satisfaction levels to refine the agent's (302, 310, 312, 314) replication of such nuanced behaviors. For instance, if the system is to mimic a certain “dressing sense” for a 3D entity representation, the Error Minimization Engine (308) would incorporate feedback on generated outfits or styles. Similarly, for voice and tones, prompts may be designed to elicit user feedback on the naturalness or appropriateness of the agent's vocal delivery in different contexts. This engine (308) ensures that the collective behavior of the primary (302) and secondary agents (310, 312, 314) converges towards a faithful and satisfactory replication of the user's intended or preferred nuanced behaviors, extending the mimicry beyond mere functional task completion to encompass more sophisticated interactional qualities. This process may involve specific error metrics designed to quantify discrepancies in stylistic elements, tonal congruence, or other defined behavioral characteristics.

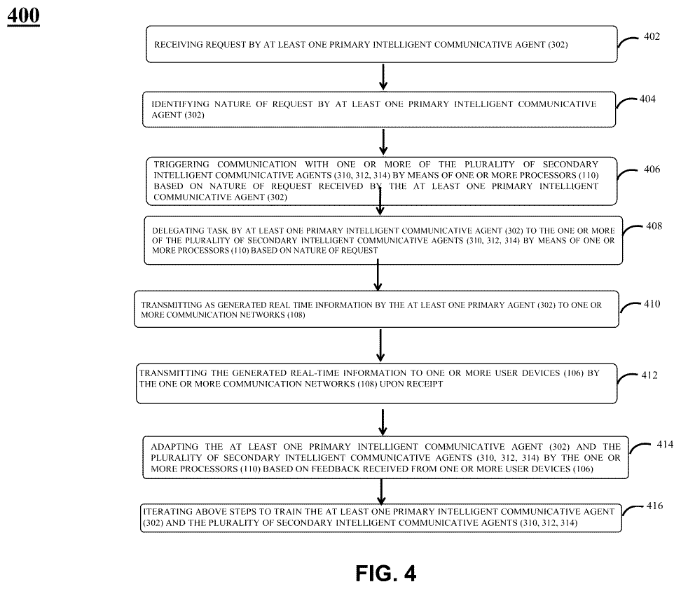

FIG. 4 depicts an example method of operation of the system (102) in accordance with an exemplary embodiment of the present disclosure. The order in which the method (400) is described is not intended to be construed as a limitation, and any number of the described method blocks may be combined in any order to implement the method (400), or an alternative method.

At block (402), the method (400) includes receiving requests by at least one primary intelligent communicative agent (302).

At block (402), the method (400) includes identifying nature of request by at least one primary intelligent communicative agent (302).

At block (406), the method (400) includes triggering communication with one or more of the plurality of secondary intelligent communicative agents (310, 312, 314) by means of one or more processors (110) based on nature of request received by the at least one primary intelligent communicative agent (302).

At block (408), the method (400) includes delegating task by at least one primary intelligent communicative agent (302) to the one or more of the plurality of secondary intelligent communicative agents (310, 312, 314) by means of one or more processors (110) based on nature of request.

At block (410), the method (400) includes transmitting real time information generated by the at least one primary agent (302) to one or more communication networks (108).

At block (412), the method (400) includes transmitting the generated real-time information to one or more user devices (106) by the one or more communication networks (108) upon receipt.

At block (410), the method (400) includes adapting the at least one primary intelligent communicative agent (302) and the plurality of secondary intelligent communicative agents (310, 312, 314) by the one or more processors (110) based on feedback received from one or more user devices (106).

At block (412), the method (400) includes iterating above steps to train the at least one primary intelligent communicative agent (302) and the plurality of secondary intelligent communicative agents (310, 312, 314).

In an aspect, further the method (400) includes configuring the one or more processors (110) to monitor and adapt to changes based on communication between the at least one primary agent (302) and the plurality of secondary intelligent communicative agents (310, 312, 314) by means of the heartbeat validation engine (304), train the plurality of secondary intelligent communicative agents (310, 312, 314) based on information received from the heartbeat validation engine (304) by the progressive training engine (306), receive real time response from the plurality of secondary intelligent communicative agents (310, 312, 314) by the output engine (316) and adapt the plurality of secondary intelligent communicative agents (310, 312, 314) based on information received from the progressive training engine (306) and the output engine (316) by the error minimization engine (308).

In an aspect, the method (400) includes configuring the error minimization engine (308) to adapt the at least one primary intelligent communicative agent (302) and the plurality of secondary intelligent communicative agents (310, 312, 314) via the heartbeat validation engine (304) and the progressive training engine (306) based on real time feedback received from one or more user devices (106).

In an aspect, the method (400) includes selectively triggering inter-communication between one or more secondary intelligent communicative agents of the plurality of secondary intelligent communicative agents (310, 312, 314) by identifying the required field.

In an aspect, the method (400) includes authenticating access to each of the plurality of secondary intelligent communicative agents (310, 312, 314) by the one or more processors (110) such that each of the plurality of secondary intelligent communicative agents (310, 312, 314) operate within the predefined field.

In an aspect, the method (400) includes performing inter-communication between at least one primary intelligent communicating agent (302) and the plurality of secondary intelligent communicative agents (310, 312, 314) and among the plurality of secondary intelligent communicative agents (310, 312, 314) by following a two-way intercommunication protocol implemented by neural networks.

In an aspect, the method (400) includes configuring a central server to store and process information exchanged through the one or more communication networks (108).

In an aspect, the method (400) includes encrypting the information stored in the database (104) for security purposes.

### Exemplary Progressive Training, Heartbeat Validation and Error Minimization Approach:

Consider a scenario within an AI-powered mobile app designed for answering user queries and providing recommendations. In this scenario, say initially, the system (102) can provide basic shopping lists based on direct user input. Then, the system (102) learns from the user's purchasing history, and it can offer more tailored suggestions. By integrating with smart appliances like fridges, the system (102) can predict grocery needs based on current inventory. Considering the preferences of household members, the system (102) can make recommendations that suit everyone's tastes. Taking into account the allocated budget, the system (102) can suggest cost-effective options.

In an alternate scenario, for example, meal planning and recipe suggestions, initially, the system (102) can generate basic meal ideas and ingredient lists. Over time, using the feature related to behavioral intelligence, the system (102) can learn preferred cuisines, dietary restrictions, and suggest recipes accordingly. Utilizing information from kitchen appliances, the system (102) can suggest recipes based on available ingredients. Considering the culinary preferences of household members, the system (102) can propose recipes that appeal to everyone. Taking into account the allocated budget, the system (102) can suggest cost-effective recipes.

Overall, this scenario exemplifies how the combination of progressive training, heartbeat validation, and error minimization training contributes to the intelligent system (102) that not only efficiently acquires information but also dynamically adapts to user preferences and provides accurate, personalized assistance across various domains.

### Exemplary Scenario 1:

Progressive training offers a dynamic approach to enhancing the capabilities of intelligent systems across various stages. Initially, the system (102) excels at compiling comprehensive lists based on user requests. For instance, the system (102) adeptly creates shopping lists, drawing from a wide range of items. This foundational capability serves as a solid base for subsequent stages of progressive training.

As the system advances, the system (102) delves into behavioral patterns. By analyzing a user's historical purchasing behavior, the system (102) gains the ability to predict future preferences. For example, if a user frequently buys organic produce, the system (102) can proactively suggest similar items in the future, aligning with the user's established preferences.

Moreover, the integration of collaborative functionalities with device agents (310) takes the system's proficiency to another level. For instance, when a user inquiries about what to purchase for dinner, the system (102) communicates with the fridge agent to ascertain the contents inside. This enables the system (102) to generate precise and relevant suggestions, optimizing the shopping experience.

Social dynamics also come into play. By considering the preferences of individuals within a household, the system (102) can generate predictions tailored to the collective tastes. For instance, if one family member craves spaghetti while another desires taco, the system (102) adeptly caters to both preferences, ensuring a harmonious shopping list.

Budgetary considerations are seamlessly integrated into the predictive process. Through collaboration with budget agents, the system (102) can generate shopping lists that align with a user's specified financial constraints. This empowers users to make economically conscious purchasing decisions without compromising on their preferences.

In essence, progressive training empowers the system (102) to evolve in tandem with user interactions. The system (102) adapts to preferences, utilizes collaborative technologies, and factors in budget constraints. From its initial capability of list compilation, the system (102) progresses to understanding behavioral patterns, collaborative tasks with device agents, accounting for social dynamics, and even financial considerations. This multifaceted approach ensures that the system's predictions and suggestions are finely tuned to the user's specific needs and circumstances.

### Working of the Invention

In view of the above-mentioned features, the following real time example may explain the functions performed by the proposed system (102).

Consider a user, Sarah, using a mobile app linked to the system (102) for managing her household groceries. This may further lead to the following steps to enable predictive grocery shopping.
1. Interaction: Sarah opens the app and says, “What do I need to buy for the week?” This request is sent securely from her phone (User Device 106) to the secure cloud-based server.
2. Primary Agent (302) Activation: The at least one primary intelligent communicative agent (302) within the server receives the request.
   It accesses Sarah's past purchasing history, dietary preferences, and saved recipes from the secure Database (104).
3. Progressive Training Engine (306) in Action:
   Device Agent (310): The primary intelligent communicative agent (302) queries the “Fridge Agent” (a type of Device Agent (310)) which securely reports the current contents of Sarah's smart fridge (e.g., low on milk, eggs expiring soon).
   Social Agent (312): The primary intelligent communicative agent (302) checks with the Social Agent (312) which notes that Sarah's partner (another household member whose preferences are securely stored) added “avocados” to a shared digital note earlier.
   Budget Agent (314): The primary intelligent communicative agent (302) consults the Budget Agent (314), which indicates Sarah has a weekly grocery budget of say $150, and some preferred budget-friendly brands based on past behavior.

The above details are transmitted to the next level by the output engine.
4. Heartbeat Validation Engine (304) & Error Minimization Engine (308) Influence:
   Previous Heartbeat Validations might have confirmed Sarah's recent shift towards more organic produce, and the model is already updated.
   Error Minimization Training ensures the prompts used by the system to clarify (if needed, e.g., “Any specific meals planned?”) are effective and that the Fridge Agent's data interpretation is accurate.
5. Response Generation: The primary intelligent communicative agent (302) compiles a prioritized shopping list:
   Milk, Eggs (from Fridge Agent)
   Avocados (from Social Agent)
   Organic spinach, chicken breasts (based on Sarah's history and recipes)
   Recommends Brand X for chicken (Budget Agent input). The list is securely sent back to Sarah's app.
6. Feedback & Learning: If Sarah removes an item or adds something unexpected, this feedback is securely sent back, potentially triggering the heartbeat validation engine (304) or contributing to error minimization engine (308) and future progressive training cycles of the progressive training engine (306) within the server.

Therefore, this entire process, from Sarah's voice command to the list appearing on her app, occurs with all sensitive data processing and inter-agent communication happening within the secure cloud-based enclave, protected by appropriate communication protocols.

For the sake of brevity, the construction and operational features of the system (102) which are explained in detail above are not explained in detail herein. Particularly, computing machines such as but not limited to internal/external server clusters, quantum computers, desktops, laptops, smartphones, tablets, and wearables may be used to execute the system (102) or may include the structure of the hardware platform. As illustrated, the hardware platform may include additional components not shown, and some of the components described may be removed and/or modified. For example, a computer system with multiple GPUs may be located on external-cloud platforms including Amazon Web Services® (AWS), internal corporate cloud computing clusters, or organizational computing resources.

The hardware platform may be a computer system such as the system (102) that may be used with the embodiments described herein. The computer system may represent a computational platform that includes components that may be in a server or another computer system. The computer system may be executed by the processor (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor that executes software instructions or code stored on a non-transitory computer-readable storage medium to perform methods of the present disclosure. The software code includes, for example, instructions to gather data and analyze the data as the plurality of modules (114).

The instructions on the computer-readable storage medium are read and stored in storage or random-access memory (RAM). The storage may provide a space for keeping static data where at least some instructions could be stored for later execution. The stored instructions may be further compiled to generate other representations of the instructions and dynamically stored in the RAM such as RAM. The processor may read instructions from the RAM and perform actions as instructed.

The computer system may further include the output device to provide at least some of the results of the execution as output including, but not limited to, visual information to users, such as external agents. The output device may include a display on computing devices and virtual reality glasses. For example, the display may be a mobile phone screen or a laptop screen. Graphical user interfaces (GUIs) and/or text may be presented as an output on the display screen. The computer system may further include an input device to provide a user or another device with mechanisms for entering data and/or otherwise interacting with the computer system. The input device may include, for example, a keyboard, a keypad, a mouse, or a touchscreen. Each of these output devices and input devices may be joined by one or more additional peripherals. For example, the output device may be used to display the results such as bot responses by the executable chatbot.

A network communicator may be provided to connect the computer system to a network and in turn to other devices connected to the network including other clients, servers, data stores, and interfaces, for example. A network communicator may include, for example, a network adapter such as a local area network (LAN) adapter or a wireless adapter. The computer system may include a data source interface to access the data source. The data source may be an information resource. As an example, a database of exceptions and rules may be provided as the data source. Moreover, knowledge repositories and curated data may be other examples of the data source.

Embodiments of the present disclosure provide systems and methods for providing progressive training, perform heartbeat validation and error minimization to intelligent communicative agents. The progressive training mechanism described herein addresses the aforementioned challenges by breaking down the training process into distinct stages, each focused on developing a specific aspect of the agent's intelligence hierarchy. This hierarchy encompasses various levels of proficiency, ranging from basic list compilation to sophisticated predictive capabilities based on behavioral, collaborative, and social insights, as well as budget considerations.

The initial stages of training concentrate on fundamental abilities, such as generating lists of items in response to user requests for potential purchases. Subsequently, the training process advances to more sophisticated stages, leveraging behavioral patterns to anticipate future preferences, collaborating with device agents to infer household needs, and incorporating social preferences into purchase predictions. Additionally, the system (102) integrates with budget agents to factor in financial constraints when making purchase recommendations.

Importantly, the inventive progressive training mechanism ensures that the acquired training information can be securely shared among multiple agents. This prevents redundant training efforts and promotes efficient knowledge transfer, leading to a more robust and capable cohort of intelligent agents.

The progressive training mechanism described herein represents a significant advancement in the field of intelligent agent systems. By providing a structured approach to training, users can engage in incremental training sessions, alleviating the need for prolonged training sessions. Moreover, the secure sharing of training information among agents minimizes redundancy and maximizes training efficiency, resulting in a more capable and resourceful collective of intelligent agents. This invention has broad applications in areas requiring intelligent decision-making and prediction, including but not limited to smart home systems, virtual personal assistants, and autonomous agents. Further, the present disclosure provides heartbeat validation mechanism to address the natural evolution of user preferences over time, a critical aspect in maintaining a dynamic and responsive AI system. By periodically checking in with users, the present disclosure ensures that its recommendations and responses remain aligned with current user preferences. This adaptive feature ensures a personalized and up-to-date experience, enhancing user satisfaction. The human-centric validation process is another distinctive advantage. Instead of relying solely on AI-generated responses, this method seeks human input, ensuring that user preferences are accurately captured. Any deviations can be promptly corrected through re-training, which ultimately leads to a higher level of system accuracy. Additionally, the system's proactive approach in correcting deviations further solidifies its reliability. If the cumulative deviation from user preferences surpasses a predetermined threshold, the system (102) takes immediate action by scheduling additional queries. This forward-thinking strategy helps maintain a consistently high level of accuracy.

Further, the present disclosure provides error minimization training designed to ensure the accurate emulation of user behavior, a crucial aspect in delivering satisfactory user experience. By utilizing prompts, gauging user satisfaction levels, and involving other agents in the decision-making process, the system (102) ensures that responses closely align with the user's intended actions. This leads to more satisfactory and effective interaction. Additionally, this training method ensures coordinated decision-making in complex scenarios. In situations where a coordinator or multiple agents contribute to the response, this method ensures that all agents in the decision path are adequately trained. This coordinated effort results in more reliable and consistent outcomes, reducing the likelihood of errors or misunderstandings. These advantages contribute to creating a more effective, efficient, and reliable AI system that can adapt to user preferences, provide accurate responses, and minimize training time and effort.

The written description describes the subject matter herein to enable any person skilled in art to make and use the embodiments. The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

We claim:

1. A system facilitating predictive behavioral analysis by integrating one or more intelligent communicative agents, the system comprising:
at least one primary intelligent communicative agent;
a plurality of secondary intelligent communicative agents, wherein each of the plurality of secondary intelligent communicative agents are associated with scope of a predefined field;
a memory unit, wherein the memory unit is configured to store information related to the at least one primary intelligent communicative agent and the plurality of secondary intelligent communicative agents;
one or more processors, wherein one or more processors is configured to trigger communicative interaction between the at least one primary agent and the plurality of secondary intelligent communicative agents, with the one or more processor comprising:
a heartbeat validation engine, wherein the heartbeat validation engine is configured to monitor and adapt to changes based on communication between the at least one primary agent and the plurality of secondary intelligent communicative agents,
a progressive training engine, wherein the progressive training engine is configured to train the plurality of secondary intelligent communicative agents based on information received from the heartbeat validation engine,
an output engine, configured to receive real time response from the plurality of secondary intelligent communicative agents,
an error minimization engine, wherein the error minimization engine is configured to adapt the plurality of secondary intelligent communicative agents based on information received from the progressive training engine and the output engine,
one or more communication networks, wherein the one or more communication networks are configured to receive as generated real time information from the at least one primary intelligent communicative agent and transmit the real-time information to one or more user devices communicatively coupled to the system; and
a database configured to receive information from the system by means of the one or more communication networks and store the information for future purposes.

2. The system according to claim 1, wherein the error minimization engine is configured to adapt the at least one primary intelligent communicative agent and the plurality of secondary intelligent communicative agents via the heartbeat validation engine and the progressive training engine based on real time feedback received by the system from one or more user devices.

3. The system according to claim 1, there is provided a central server configured to store and process information exchanged through the one or more communication networks.

4. The system according to claim 1, wherein the one or more processors are configured to selectively trigger inter-communication between the at least one primary intelligent communicative agent and the plurality of secondary intelligent communicative agents by identifying the required field upon receipt of request by means of the one or more user devices.

5. The system according to claim 1, wherein the at least one primary communicative agent is configured to delegate task to one or more of the plurality of secondary intelligent communicative agents upon identifying required field of request.

6. The system according to claim 1, wherein the information stored in the database is encrypted for security purposes.

7. The system according to claim 1, wherein the one or more processors comprises of an access control device configured to authenticate access to each of the plurality of secondary intelligent communicative agents such that each of the plurality of secondary intelligent communicative agents operate within the predefined field.

8. The system according to claim 1, wherein at least one primary intelligent communicative agent co-ordinates with each of the plurality of secondary intelligent communicative agents and among the plurality of secondary intelligent communicative agents by following a two-way intercommunication protocol implemented by neural networks thereby dynamically adjusting communication pathway.

9. The system according to claim 8, wherein the at least one primary intelligent communicative agent is configured to weigh inputs received from each of the plurality of secondary intelligent communicative agents based on their relevance to the current task and their historically validated performance within their predefined field.

10. The system according to claim 1, wherein the system is configured to allow independent inter-communication between each of the plurality of secondary intelligent communicative agents.

11. The system according to claim 1, wherein the plurality of secondary intelligent communicative agents may include but is not limited to device agent, social agent, budget agent and the like.

12. A method for facilitating predictive behavioral analysis by integrating one or more intelligent communicative agents, the method comprising:
receiving request by at least one primary intelligent communicative agent;
identifying nature of request by at least one primary intelligent communicative agent;
triggering communication with one or more of the plurality of secondary intelligent communicative agents by means of one or more processors based on nature of request received by the at least one primary intelligent communicative agent;
delegating task by at least one primary intelligent communicative agent to the one or more of the plurality of secondary intelligent communicative agents by means of one or more processors based on nature of request;
transmitting as generated real time information by the at least one primary agent to one or more communication networks;
transmitting the generated real-time information to one or more user devices by the one or more communication networks upon receipt;
adapting the at least one primary intelligent communicative agent and the plurality of secondary intelligent communicative agents by the one or more processors based on feedback received from one or more user devices; and
iterating above steps to train the at least one primary intelligent communicative agent and the plurality of secondary intelligent communicative agents.

13. The method according to claim 12, wherein the method includes configuring the one or more processors to:
monitor and adapt to changes based on communication between the at least one primary agent and the plurality of secondary intelligent communicative agents by a heartbeat validation engine;
train the plurality of secondary intelligent communicative agents based on information received from the heartbeat validation engine by a progressive training engine;
receive real time response from the plurality of secondary intelligent communicative agents by an output engine; and
adapt the plurality of secondary intelligent communicative agents based on information received from the progressive training engine and the output engine by an error minimization engine.

14. The method according to claim 13, wherein the method includes configuring the error minimization engine to adapt the at least one primary intelligent communicative agent and the plurality of secondary intelligent communicative agents via the heartbeat validation engine and the progressive training engine based on real time feedback received from one or more user devices.

15. The method according to claim 12, wherein the method includes selectively triggering inter-communication between one or more secondary intelligent communicative agents of the plurality of secondary intelligent communicative agents by identifying the required field.

16. The method according to claim 12, wherein the method includes authenticating access to each of the plurality of secondary intelligent communicative agents by the one or more processors such that each of the plurality of secondary intelligent communicative agents operate within the predefined field.

17. The method according to claim 12, wherein the method includes performing inter-communication between at least one primary intelligent communicating agent and the plurality of secondary intelligent communicative agents and among the plurality of secondary intelligent communicative agents by following a two-way intercommunication protocol implemented by neural networks.

18. The method according to claim 12, wherein the method includes configuring a central server to store and process information exchanged through the one or more communication networks.

19. The method according to claim 12, wherein the method includes encrypting the information stored in the database for security purposes.

20. A non-transitory machine-readable medium including data, which when used by a system for facilitating predictive behavioral analysis by integrating one or more intelligent communicative agents, causes the system to perform instructions that cause the system to perform operations, comprising:
receiving request by at least one primary intelligent communicative agent;
identifying nature of request by at least one primary intelligent communicative agent;
triggering communication with one or more of the plurality of secondary intelligent communicative agents by means of one or more processors based on nature of request received by the at least one primary intelligent communicative agent;
delegating task by at least one primary intelligent communicative agent to the one or more of the plurality of secondary intelligent communicative agents by means of one or more processors based on nature of request;
transmitting as generated real time information by the at least one primary agent to one or more communication networks;
transmitting the generated real-time information to one or more user devices by the one or more communication networks upon receipt;
adapting the at least one primary intelligent communicative agent and the plurality of secondary intelligent communicative agents by the one or more processors based on feedback received from one or more user devices; and
iterating above steps to train the at least one primary intelligent communicative agent and the plurality of secondary intelligent communicative agents.
